(19) United States
(12) Patent Application Publication
(10) Pub. No.: US 2026/0056109 A1
(43) Pub. Date: Feb. 26, 2026

(54) COMBINING DLS AND SLS FOR NUMBER DENSITY ESTIMATION

(71) Applicant: Dimer Instruments, Inc., Santa Barbara, CA (US)

(72) Inventors: Michael I. Larkin, Santa Barbara, CA (US); Craig K. Abbey, Santa Barbara, CA (US)

(21) Appl. No.: 18/810,886

(22) Filed: Aug. 21, 2024

(51) Int. Cl. G01N 15/0205; G01N 15/00

(52) U.S. Cl. CPC G01N 15/0211; G01N 2015/0222; G01N 2015/03

(57) ABSTRACT

A method, system, and apparatus for combining DLS and SLS for number density estimation is disclosed. An example measurement device includes a sample holder containing at least a first sample, a set of optics, and a scanning mechanism to scan the sample holder relative to the set of optics. The example set of optics includes illumination optics. The example set of optics further includes a first detector beam configured for standard dynamic light scattering (DLS). The example set of optics further includes a second detector beam configured for enhancing DLS regularization with static light scattering (SLS) information.

### BACKGROUND

The development of biopharmaceuticals, particularly monoclonal antibodies (mAbs) and antibody-drug conjugates (ADCs), requires rigorous characterization and formulation screening to ensure stability, efficacy, and safety. Due to its rapid and non-invasive nature, dynamic light scattering (DLS) has been extensively used in these applications to inform these analyses.

DLS is a technique where a laser is focused into a small volume of solution and the scattered light is collected by a detector as a known angle. Random Brownian motion of the scatters (i.e., the molecules in solution) causes the intensity at the detector to vary with time. From this variation, an autocorrelation function is measured, and then mathematically inverted to obtain a distribution of diffusion coefficients, and in turn, particle sizes. This technique is well known to those skilled in the art.

On many pharmaceutical samples, DLS provides crucial data on hydrodynamic radius (Rh) and polydispersity. When the samples are measured at different temperatures, pH, and/or salt concentration, DLS can provide additional information on denaturation or melting point of the samples. This information is used to determine and optimize the stability of a particular formulation.

Nonetheless, DLS suffers from several limitations. One of the most critical of these limitations is the low information content in the measured signal. The major difficulty lies in the inversion of the measured data, which is essentially inverting the Laplace transform; an ill-posed problem possessing no unique solution. Many approaches have been taken to tackle this mathematical problem, with the most widely used techniques being the method of cumulants, the CONTIN algorithm, and non-negative least squares. These techniques attempt to determine the particle size and distribution using a range of constraints which limit the possible solutions to the mathematical problem. The advantages and disadvantages of each have been explored by a number of authors in scientific literature. Therefore, there is a need for an approach to better constrain the mathematical inversion of measured DLS signals in order to accurately determine particle size and distribution of a sample.

### SUMMARY

Disclosed herein are methods, systems, and apparatus for combining DLS and static light scattering (SLS) for number density estimation. As described above, DLS could be greatly improved if the mathematical inversion of measured DLS signals could be better constrained. A method for better constraining the mathematical inversion of measured DLS signals disclosed herein includes measuring additional data from the sample could be added to the signal to better constrain the mathematical inversion.

This application discloses an approach for obtaining DLS autocorrelation function (ACF) data and combining it with SLS data acquired with the measurement volume and sample moving with respect to each other (volume moving or sample moving) to generate an improved estimate of the number distribution of molecules and particles in solution as a function of hydrodynamic radius, n(rₕ).

Static light scattering (SLS) is an orthogonal technique to DLS in that the light scattered from the sample is not collected over time, but instead over different angles (e.g., relative to the incident beam). The scattered light's intensity angular variation is described by Mie scattering theory. By applying Mie theory, the shape and magnitude of the scattering function can be used to determine the size and molar mass of the particles in solution. When using SLS, small particles exhibit almost no angular variation, while large particles have significant structure as a function of angles.

There have been numerous attempts to take advantage of the angular variation of SLS to provide additional information to the DLS mathematical inversion problem. For example, if there are two species in a solution that cannot be resolved by traditional DLS, the angular variation of the strength of the signals from each species can be used to enhance the mathematical inversion by taking DLS data at multiple angles. This approach improves the DLS analysis but comes at considerable instrumentation cost and complexity. Furthermore, in the pharmaceutical industry, the preferred sample format is the standard multi-well plate (see FIG. 1 discussed below), which is only optically accessible through the bottom of the plate from a very limited number of angles. Thus, multiangle DLS is not practical.

This application proposes a novel approach to integrate SLS data taken over time, and in some cases scanned through a volume, with standard DLS to enhance the DLS regularization algorithm. The improved regularization algorithm enables more precise determination of hydrodynamic radius and polydispersity, thereby optimizing formulation and process development in pharmaceutical manufacturing. An additional benefit of the approach is it does not require multiple DLS detectors at multiple angles and is therefore suitable for applications which have limited optical access, such as in the pharmaceutical industry's standard multi-well plate.

DLS and SLS measurements are differentiated from each other by the timescales of measurement of the intensity through time. DLS measurements occur with very high resolution in time (e.g., 10-100 nanosecond resolution). Thus, DLS measurements provide the ability to measure changes in the intensity of scattered light that result from interference effects as particles move quickly relative to each other due to diffusion, with the light scattered from one particle interfering constructively or destructively with light scattered from all other particles. In DLS, the measured changes in the intensity through time typically occurring on the timescales of usec to msec. In contrast, SLS measurements are typically made with sufficient time averaging such that diffusion effects are averaged out and the mean intensity only is measured. However, the SLS mean intensity will still change through time as the number and/or size of particles in the measurement volume changes.

DLS data are commonly interpreted using the method of regularization to estimate the distribution of particle sizes present in a sample. The regularization method is powerful, but low resolution and with a poor ability to provide reliable quantitative number density as a function of radius, especially for sizes above a hydrodynamic radius r≥50 nm. In regularization, a minimization method is used to find a light intensity weighted distribution of correlation rates Γ (proportional to one over the hydrodynamic radius, 1/r) that best fits the DLS ACF data. However, this is a classic “ill posed” problem in that a very broad range of distributions usually fit the data equally well within statistical significance.

A “regularizer” is typically added to the minimization criteria to choose amongst the otherwise equivalently good solutions. A regularizer commonly used is the sum over the second derivative of the number distribution n(r) with respect to r, thereby weighting the fit towards the smoothest distribution that fits the data. The method disclosed herein replaces or supplements the regularizer term with additional criteria that must be met based upon SLS data that are orthogonal to the DLS data. In addition to acquiring traditional DLS ACF data, as a second step, examples disclosed herein move the sample relative to the measurement volume and record the SLS intensity through time (SLS-ITT) as particles cross through the measurement volume. Requiring that n(r) satisfy both the traditional DLS data and also the SLS-ITT data can result in improved resolution and quantitative accuracy in the estimated n(r).

Disclosed herein are three types of information that may be generated from SLS-ITT data that may be included in a combined DLS/SLS fitting for the determination of particle size distribution. The first type of information is a distribution of maximum peak heights for individual particles passing through the detection volume, for samples with particle number densities low enough such that on average there are fewer than 1 in the measurement volume at any one time. The second type of information is peak width distributions associated with diffusion of the particles during the time that they are transiting the detection volume. The third type of information is the moments in the distribution of the SLS intensity through time (e.g. variance, skew, kurtosis, etc.) associated with low-N number fluctuation for particles with number densities such that N≤500 are in the measurement volume.

The term “particle” as used herein means molecules, grouping of molecules, and nanoparticles, including lipid nanoparticles, viruses, virus like particles, etc.

Aspects of the subject matter described herein may be useful alone or in combination with one or more other aspect described herein. Without limiting the foregoing description, in a first aspect of the present disclosure, a measurement device includes a sample holder containing at least a first sample, a set of optics including illumination optics, a first detector beam configured for standard dynamic light scattering (DLS), and a second detector beam configured for enhancing DLS regularization with static light scattering (SLS) information, and a scanning mechanism to scan the sample holder relative to the set of optics.

In accordance with a second aspect of the present disclosure, which may be used in combination with the first aspect, the illumination optics includes a single laser beam for both the first detector beam and the second detector beam.

In accordance with a third aspect of the present disclosure, which may be used in combination with any other aspect disclosed herein, the first detector beam and the second detector beam are directed to approximately the same position on the single laser beam.

In accordance with a fourth aspect of the present disclosure, which may be used in combination with any other aspect disclosed herein, the first detector beam is directed to a first position on the single laser beam and the second detector beam is directed to a second position on the single laser beam and wherein the first position and the second position are both within an in-focus range of the single laser beam.

In accordance with a fifth aspect of the present disclosure, which may be used in combination with any other aspect disclosed herein, the illumination optics include a first laser beam for the first detector beam and a second laser beam for the second detector beam and wherein a first measurement volume is formed by the first laser beam and the first detector beam and a second measurement volume is formed by the second laser beam.

In accordance with a sixth aspect of the present disclosure, which may be used in combination with any other aspect disclosed herein, the first measurement volume and the second measurement volume are in the first sample.

In accordance with a seventh aspect of the present disclosure, which may be used in combination with any other aspect disclosed herein, the scanning mechanism moves the first sample relative to the set of optics for sequential acquisition of SLS and DLS data.

In accordance with an eighth aspect of the present disclosure, which may be used in combination with any other aspect disclosed herein, the measurement device further includes a second sample contained in a second sample holder, and wherein the first measurement volume is in the first sample and the second measurement volume is in the second sample.

In accordance with a ninth aspect of the present disclosure, which may be used in combination with any other aspect disclosed herein, the first sample and the second sample include duplicate sample material.

In accordance with a tenth aspect of the present disclosure, which may be used in combination with any other aspect disclosed herein, an intensity profile of the second detector beam is a Gaussian profile.

In accordance with an eleventh aspect of the present disclosure, which may be used in combination with any other aspect disclosed herein, an intensity profile of the second detector beam is a top hat profile.

In accordance with a twelfth aspect of the present disclosure, which may be used in combination with any other aspect disclosed herein, the SLS information is one or more of a distribution of peak heights, a distribution of peak widths, and moments of an intensity distribution.

In accordance with a thirteenth aspect of the present disclosure, which may be used in combination with any other aspect disclosed herein, the sample holder is a well of a multiwell plate.

In accordance with a fourteenth aspect of the present disclosure, which may be used in combination with any other aspect disclosed herein, the sample holder is a cuvette.

In accordance with a fifteenth aspect of the present disclosure, which may be used in combination with any other aspect disclosed herein, a size of the second detector beam is substantially smaller than a size of the first detector beam.

In accordance with a sixteenth aspect of the present disclosure, which may be used in combination with any other aspect disclosed herein, a size of the second detector beam is approximately the same as a size of the first detector beam.

In accordance with a seventeenth aspect of the present disclosure, which may be used in combination with any other aspect disclosed herein, a method for estimating a particle size distribution of a sample includes acquiring DLS data for a sample; acquiring SLS data for the sample; and combining the DLS data and the SLS data to estimate the particle size distribution of the sample.

In accordance with an eighteenth aspect of the present disclosure, which may be used in combination with any other aspect disclosed herein, the SLS data is one or more of a distribution of peak heights, a distribution of peak widths, and moments of an intensity distribution.

In accordance with a nineteenth aspect of the present disclosure, which may be used in combination with any other aspect disclosed herein, an illumination beam for acquiring the DLS data is the same beam as an illumination beam for acquiring the SLS data.

In accordance with a twentieth aspect of the present disclosure, which may be used in combination with any other aspect disclosed herein, acquiring the SLS data includes one of (i) moving the sample relative to a measurement volume or (ii) moving the measurement volume relative to the sample; and recording an SLS intensity through time (SLS-ITT) as particles of the sample cross through the measurement volume.

In accordance with a twenty-first aspect of the present disclosure, any of the structure and functionality illustrated and described in connection with FIGS. 1 to 16 may be used in combination with any of the structure and functionality illustrated and described in connection with any of the other of FIGS. 1 to 16 and with any one or more of the preceding aspects.

In light of the present disclosure and the above aspects, it is therefore an advantage of the present disclosure to enhance the DLS regularization algorithm and generate an improved estimate of the number distribution of molecules and particles in solution as a function of hydrodynamic radius.

It is another advantage of the present disclosure to enable more precise determination of hydrodynamic radius and polydispersity, thereby optimizing formulation and process development in pharmaceutical manufacturing.

It is a further advantage of the present disclosure to perform such enhancement to DLS without requiring multiple DLS detectors at multiple angles and, thus, the present disclosure is suitable for applications with limited optical access.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a diagram showing an example optical system, according to an example embodiment of the present disclosure.

FIG. 2 is a schematic diagram illustrating a laser launch beam and collector beam cross to create a detection volume, according to an example embodiment of the present disclosure.

FIG. 3 is a diagram illustrating SLS intensity through time with the measurement volume moving with respect to a sample containing dilute large particles.

FIG. 4A is a diagram illustrating example intensity through time for the case of more than one particle on average in the measurement volume, with different species present, according to an example embodiment of the present disclosure.

FIG. 4B is a diagram illustrating the resulting distribution of intensities from the intensity diagram of FIG. 4A, according to an example embodiment of the present disclosure.

FIG. 5 is a diagram illustrating an example measurement system for combining DLS and SLS, according to an example embodiment of the present disclosure.

FIG. 6 is a diagram illustrating a second example measurement system for combining DLS and SLS, according to an example embodiment of the present disclosure.

FIG. 7 is a schematic diagram of a simplified case of laser and collector intersecting at 90 deg, according to an example embodiment of the present disclosure.

FIG. 8 is a diagram illustrating detection efficiency d as a function of (x,z) in the y=0 plane, according to an example embodiment of the present disclosure.

FIG. 9A is a diagram illustrating the distribution of peak heights is given by the relative area of a range of detection efficiencies, according to an example embodiment of the present disclosure.

FIG. 9B is another diagram illustrating the distribution of peak heights is given by the relative area of a range of detection efficiencies, according to an example embodiment of the present disclosure.

FIG. 10 is a diagram illustrating expected distribution of peak heights from a single species with intersecting Gaussian beams, according to an example embodiment of the present disclosure.

FIG. 11A is a schematic diagram illustrating a Gaussian laser intersecting with a “top hat” collector, according to an example embodiment of the present disclosure.

FIG. 11B is diagram illustrating peak intensity regions for the configuration of FIG. 11A, according to an example embodiment of the present disclosure.

FIG. 11C is a diagram illustrating the distribution of peak intensities corresponding to FIG. 11B, according to an example embodiment of the present disclosure.

FIG. 12 is a diagram illustrating expected distribution of peak heights from a single species for a Gaussian laser launch beam and a “top hat” collector profile, according to an example embodiment of the present disclosure.

FIG. 13 is a diagram illustrating average distance traveled due to diffusion during transit as a function of radius for a transit time of 1 second, according to an example embodiment of the present disclosure.

FIG. 14A is a diagram illustrating intensity through time for a sample having 1600 particles/mm³, according to an example embodiment of the present disclosure.

FIG. 14B is a diagram illustrating intensity through time for a sample having 6400 particles/mm³, according to an example embodiment of the present disclosure.

FIG. 14C is a diagram illustrating intensity through time for a sample having 26,000 particles/mm³, according to an example embodiment of the present disclosure.

FIG. 14D is a diagram illustrating intensity through time for a sample having 410,000 particles/mm³, according to an example embodiment of the present disclosure.

FIG. 15 is a diagram illustrating changes in the relative moments of the intensity distribution as a function of number density for a single species in solution, according to an example embodiment of the present disclosure.

FIG. 16 is a flow diagram illustrating an example procedure for estimating a particle size distribution, according to an example embodiment of the present disclosure.

### DETAILED DESCRIPTION

The present disclosure relates in general to a method, system, and apparatus for combining DLS and SLS for number density estimation. As disclosed herein, the method comprises obtaining DLS autocorrelation function (ACF) data and combining it with SLS data to generate an improved estimate of the number distribution of molecules and particles in solution as a function of hydrodynamic radius.

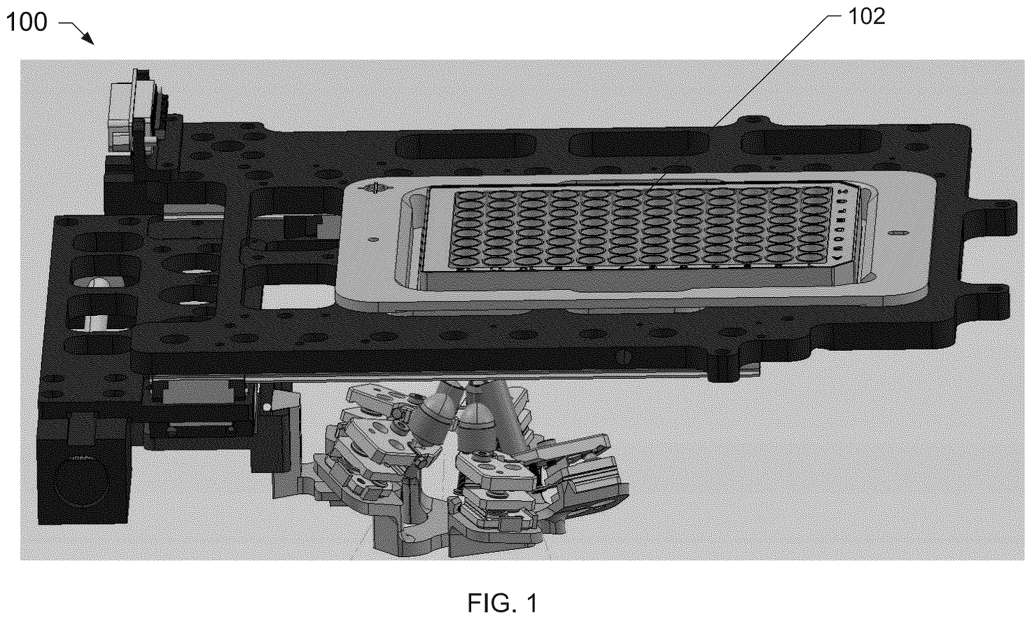

FIG. 1 shows an example optical system 100 using a standard well plate 102. In this example, the optical system 100 is a multi-well plate based static light scattering and dynamic light scattering instrument for measuring stability in pharmaceutical formulation processes. In this optical system 100, illumination and collection optics must be focused through the transparent bottom of the standard well plate 104, at a known fixed distance above the well bottom. The locations of focus for both the illumination and collection optics must be positioned relative to each other, and to the well, withing the gaussian diameter of the beams, or much less than 40 um. As discussed above, because the standard multi-well plate 102 is only optically accessible through the bottom of the plate 102 from a very limited number of angles, multiangle DLS is not practical. Thus, there is a need to enhance the DLS regularization algorithm without requiring multiple DLS detectors at multiple angles.

Regularization Methods for Determining Particle Size Distribution from DLS Alone

For DLS measurements of a single size species (e.g. molecules, virii, nanoparticles, etc.) in solution undergoing translation diffusion (i.e., Brownian motion), the intensity autocorrelation function g₂(τ) (as opposed to the E-field correlation function g₁(τ)) is given by an exponential function with a single exponential decay rate represented in Equation 1 below where τ is the delay or lag time, β is the amplitude of the autocorrelation function, and the correlation rate Γ is given by Equation 2 below. The scattering wave vector amplitude q of Equation 2 is given by Equation 3 below where n₀ is the refractive index of the solution, λ₀ is the vacuum wavelength of the light being scattered, and θ is the scattering angle. The diffusion constant D of Equation 3 is given by Equation 4 below where k_{B} is the Boltzmann constant, T is the absolute temperature, η is the viscosity of the solution, and r is the hydrodynamic (spherical equivalent) radius of the particle.

$${g}_{2} ( τ ) = 1.0 + β {e}^{- 2 Γ τ} \qquad ( Equation 1 )$$

$$Γ = {q}^{2} D \qquad ( Equation 2 )$$

$$q = ( \frac{4 π {n}_{0}}{{λ}_{0}} ) sin ( \frac{θ}{2} ) \qquad ( Equation 3 )$$

$$D = \frac{{k}_{B} T}{6 π η r} \qquad ( Equation 4 )$$

For multiple species in solution the measured intensity autocorrelation function is given by Equation 5 below where G(Γ) is the relative scattering intensity into a DLS detector from a species having a correlation rate of Γ. This is a combination of exponential functions, with the relative amplitudes of the exponential functions given by the relative scattering intensities from the various species. The square outside the bracket results in a mixing between all individual exponential terms, with every exponential term multiplied by every other term.

$${g}_{2} ( τ ) = 1.0 + {β [ {\int }_{0}^{∞} G ( Γ ) {e}^{- Γ τ} d Γ ]}^{2} \qquad ( Equation 5 )$$

The desired endpoint of many DLS measurements is to determine the number or mass distribution of species present in solution as a function of the particle size, n(r), which may be directly calculated from G(Γ). In the discussion below, G(Γ) is used approximately interchangeably with n(r), knowing that one may be transformed into the other.

At first glance one might assume that determination of G(Γ) may be achieved in a straightforward way by inverting Equation 5 and solving the resulting inverse Laplace transform to obtain G(Γ) as represented in Equation 6 below where [symbol] denotes the inverse Laplace transform.

$$G ( Γ ) = {ℒ}^{- 1} \{ {[ \frac{1}{β} [ {g}_{2} ( τ ) - 1 ] ]}^{1 / 2} \} \qquad ( Equation 6 )$$

However, in the absence of data with infinite extent in time, and with the presence of any finite noise in the measurement, Equation 6 is a classic “μl-posed problem,” where there are an infinite number of distributions G(Γ) which will fit the data equally well within statistical uncertainty. A data analysis method typically used to overcome this challenge is to use one of many possible “regularization” methods, where an a-priori assumption is made not directly supported by the data, and a fit of the data to potential distributions is weighted using the a-priori assumption. One generally estimates G(Γ) in this way by using some variation on the method of nonlinear least squares, using any of many possible techniques to minimize a chi-squared which is given as Equation 7 below, where w_{reg} is the weighting given by the regularization term as discussed further below, and chi-squared from the autocorrelation function

$${χ}_{DLS}^{2}$$

is given as Equation 8 below.

$${χ}^{2} = {χ}_{DLS}^{2} + {w}_{reg}^{2} \qquad ( Equation 7 )$$

$${χ}_{DLS}^{2} = {\sum }_{n} {\{ \frac{{g}_{2 , measured} ( {τ}_{n} ) - {g}_{2 , model ( {τ}_{n} )}}{{σ}_{g2 , m} ( {τ}_{n} )} \}}^{2} \qquad ( Equation 8 )$$

In Equation 8, the summation is over the n measured correlation delay time points, σ_{g2,m}(τₙ) is the estimated noise (typically a standard deviation) in the measured autocorrelation function at time τₙ, and g_{2,model}(τₙ) is given as Equation 9 below. Equation 9 represents the model autocorrelation function which is calculated from the model distribution of correlation rates G_{model}(Γₘ), and where the summation is over the discreet correlation rates Γₘ used when modeling.

$${g}_{2 , model} ( {τ}_{n} ) = 1.0 + {β [ {\sum }_{m} {G}_{model} ( {Γ}_{m} ) {e}^{- {Γ}_{m} τ} ]}^{2} \qquad ( Equation 9 )$$

As discussed above, a regularization term can be used to weight the solutions in various ways, with one possibility being to favor smooth distributions over spikey distributions. This can be accomplished by minimizing the sum S over the second derivatives of the distribution G(Γ), calculated as Equation 10 below, where δΓ is the spacing between adjacent correlation rates (under the simplifying assumption of equal spacing, for illustrative purposes) and using w_{reg} as given by Equation 11 below. In Equation 11, α is the “regularizer” term. The regularizer term α is adjusted between 0 and some value to set the importance of the smoothness of the distribution when selecting between possible solutions for G_{model}(Γ).

$$S = \frac{1}{{( δ Γ )}^{2}} {\sum }_{m} \{ {G}_{model} ( {Γ}_{m + 2} ) - 2 {G}_{model} ( {Γ}_{m + 1} ) + {G}_{model} ( {Γ}_{m} ) \} \qquad ( Equation 10 )$$

$${w}_{reg} = α S \qquad ( Equation 11 )$$

The end result of this data analysis method is G_{model}(Γₘ) estimated from g_{2,measured}(τₙ). This estimate relies on one or more a-priori assumptions being valid, e.g. that a smooth distribution is more likely the correct distribution. The DLS method described above is powerful and useful despite this uncertainty and the requirement for a-priori knowledge not derived directly from the data.

Disclosed below are several inventive ways to acquire and use additional data orthogonal to traditional DSL data that may be used instead of or in addition to a regularization term to constrain the possible distribution of sizes. Using addition orthogonal data can result in more accurate and precise estimates of the distribution of particle sizes present in a sample.

### Overview of Static Light Scattering Intensity Through Time (SLS-ITT) Data

Below provides a summary of three separate SLS-ITT methods: (1) distribution of peak heights, (2) distribution of peak widths, and (3) moments of the intensity distribution.

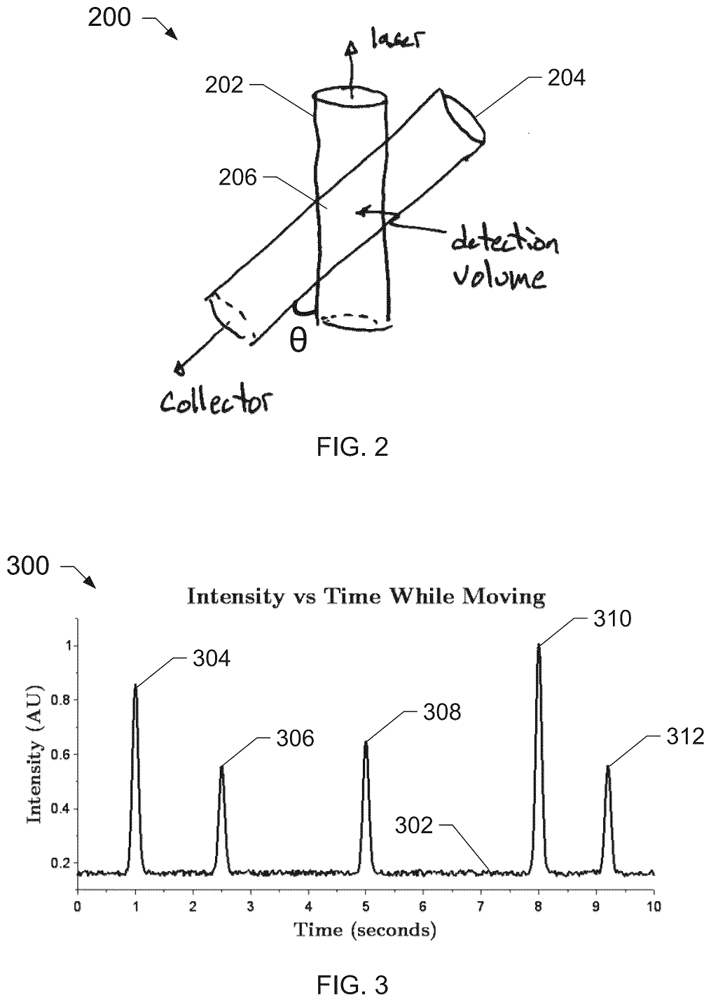

FIG. 2 is a schematic diagram 200 illustrating an illumination beam 202 (e.g., a laser beam, a laser launch beam) and collector beam 204 crossing in space to create a detection volume 206 (V). Consider a liquid solution containing a dilute suspension of particles, where each individual particle scatters enough light to be robustly detected by a static light scattering detector, and where the particle number density n with respect to the measurement volume V is small enough such that nV<<1. In this case, most of the time there are no particles in the measurement volume, and only occasionally will a particle enter the measurement volume. As a result of particles diffusing into and out of the measurement volume, the intensity fluctuates through time. By measuring intensity fluctuations through time due to the change in the number of particles diffusing into and out of the measurement through time, it is possible to estimate the number density n. However, with this method, it can take many hours of data acquisition from a single sample in order to acquire the statistics needed to make reasonable estimates of n for a single species in solution, and estimating multiple n from multiple species using this method would take much longer and is not a known approach.

### Distribution of Peak Heights

FIG. 3 is a diagram 300 illustrating an SLS intensity curve 302 as a function of time. Instead of waiting for particles to move into and out of the detection volume due to diffusion, the detection volume may be moved relative to the sample. In this case, there will be peaks (e.g., peak 304, peak 306, peak 308, peak 310, peak 312) in the intensity of light as the detection volume is swept across individual particles, as shown in FIG. 3. With this SLS-ITT data acquisition method, data may be acquired much more quickly than with a stationary detection volume as described in the above section. As such, when coupled with appropriate inventive analysis methods, this SLS-ITT data acquisition method can provide information regarding not only the number density n of a single species in solution, but the number density of many species as a function of particle radius n(r), equivalent to G(Γ).

As discussed in the Distribution of Peak Heights Method section below, the distribution of peak heights (e.g., the heights of peaks 304, 306, 308, 310, 312) seen in FIG. 3 is due both to the variation in how close to the center of the beams the particles pass through the measurement volume, and also due to the distribution of particle sizes n(r) present. If traditional DLS data are acquired from a sample, and independently SLS-ITT distribution of peak data are acquired from the same sample, then by requiring that model distributions G(Γ) (equivalent to n(r)) satisfy both datasets can result in more accurate and precise estimates of the distribution of particle sizes.

### Distribution of Peak Widths

In a second method for SLS-ITT, distribution of peak widths is analyzed. To first order the peak widths in time shown in FIG. 3 are given by the velocity of the sample solution with respect to the measurement volume and the width of the measurement volume in the direction of movement at the position of the sample crossing. If the diffusion time constant of a particle is not much smaller than the transit time of a particle across the measurement volume, then there will additionally be an overall broadening of the distribution of transit times to both slightly longer and slightly shorter transit times. In section Distribution of Peak Widths Method below, a method for combining peak width data with traditional DLS data and optionally with other datasets such as peaks heights data to further constrain n(r) is discussed. The method discussed below may result in more accurate and precise estimates of the distribution of particle sizes.

### Moments of the Intensity Distribution

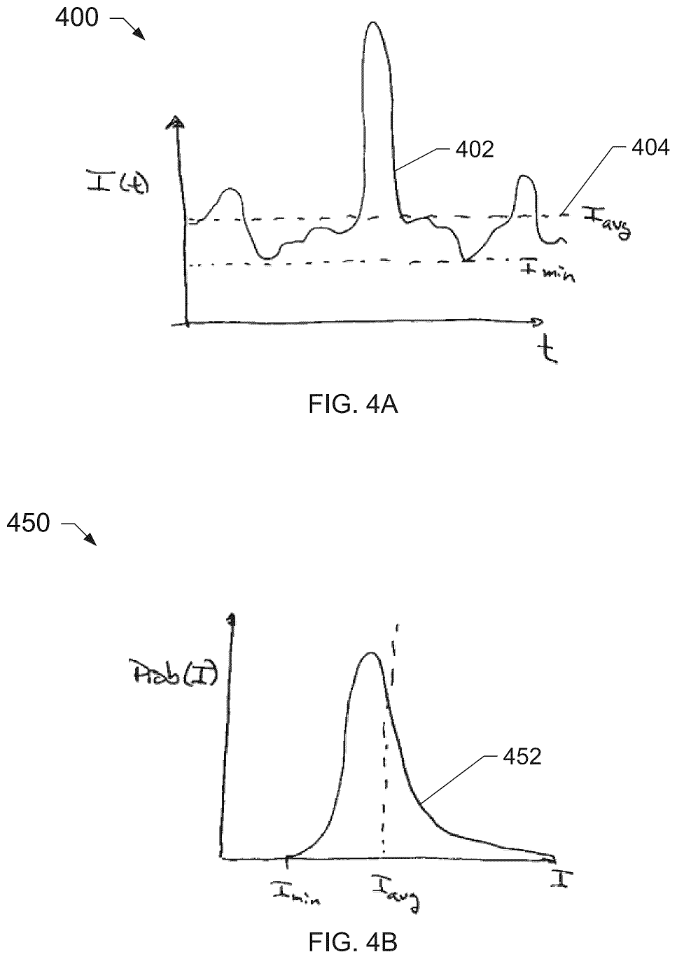

In a third method for SLS-ITT, the condition that there are on average fewer than one particle in the measurement volume at a time is relaxed. FIG. 4A shows a diagram 400 illustrating example intensity through time 402 for the case of more than one particle on average in the measurement volume, with different species present. Given N=nV particles in the measurement volume on average, the time averaged intensity of scattered light 404 is generally proportional to N and, therefore, the first moment in the distribution of the intensity of light through time for a single species in solution is proportional to N. As the sample volume is changed through time (e.g. due to movement of the sample with respect to the measurement volume) there are fluctuations in the number of particles in the volume given by σ_{N}=\sqrt{N}. These fluctuations result in the second moment of the intensity distribution being generally proportional to \sqrt{N}. Light scattering signals are generally positive over background, and so there is generally a non-zero third moment of the intensity distribution.

FIG. 4B shows a diagram 450 illustrating the resulting distribution of intensities 452 from the intensity diagram 400 of FIG. 4A. In the section Moments of the Intensity Distribution Method below, it is shown how moments of the probability distribution of the intensity through time P(I) depend on the number density of a species. In general, P(I) and the moments of the distribution of P(I) depend upon the distribution n(r). Thus, measured moments of the P(I) distribution may be combined with traditional DLS data and optionally with datasets to better constrain n(r). Better constraining n(r) may result in more accurate and precise estimates of the distribution of particle sizes.

### Combining DLS and SLS for Improved Number Density Estimation

Disclosed herein are methods for improving DLS by utilizing a combined DLS/SLS data fitting. The combined DLS/SLS data fitting may be performed using a distribution of maximum peak heights data generated from SLS-ITT, a distribution of peak width distributions data generated from SLS-ITT, or moments in the distribution of the SLS intensity through time generated from SLS-ITT.

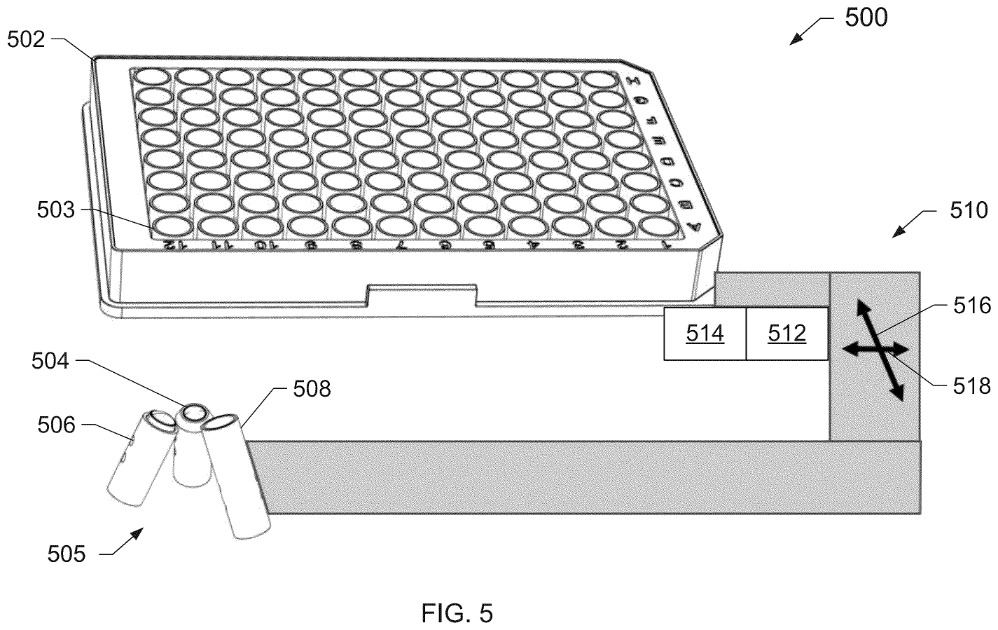

An example measurement system 500 for combining DLS and SLS is shown in FIG. 5. The example measurement system 500 includes a multiwell plate 502 including a plurality of sample holders 503 (e.g., wells), a set of optics 505, and a scanning mechanism 510. In other examples, the sample holders 503 may be in a form other than a wall of a multiwell plate (e.g., a cuvette, capillary, capillary array, micro-fluidic device). One or more of the sample holders 503 may include one or more samples (e.g., pharmaceutical samples) on which DLS analysis is to be performed.

The example set of optics 505 includes illumination optics 504 (e.g., a laser source, laser optics, laser launch optics), DLS collection optics 506 (e.g., DLS detector optics), and SLS collection optics 508 (e.g., SLS detector optics). The example illumination optics 504 are configured to output an illumination beam (e.g., a laser beam). The example DLS collection optics 506 are configured to output a DLS beam (e.g., a DLS collection beam, a DLS detector beam, a detector beam) configured for standard DLS. The example SLS collection optics 508 are configured to output an SLS beam (e.g., an SLS collection beam, an SLS detector beam, a detector beam) configured for enhancing DLS regularization with SLS information. In some examples, the SLS beam has a Gaussian intensity profile. In other examples, the SLS beam has a top hat intensity profile, as described below.

The DLS beam output by the example DLS collection optics 506 has a first beam size (e.g., a beam radius, a beam diameter) while the SLS beam output by the example SLS collection optics 508 has a second beam size. In some examples, the second size of the SLS beam is substantially smaller (e.g., 10% or less, 5% or less, 1% or less) of the first size of the DLS beam. In other examples, the second size of the SLS beam is approximately the same (e.g., within 10%, within 5%, within 1%) of the first size of the DLS beam.

The example laser beam and the example DLS beam intersect at a first location on the laser beam to form a first measurement volume (e.g., a first launch measurement volume, a first collection measurement volume). The example laser beam and the example SLS beam intersect at a second location on the laser beam to form a second measurement volume (e.g., a second launch measurement volume, a second collection measurement volume). In some examples, the first location on the laser beam and the second location on the laser beam are the same or approximately the same. In other examples, the first location and the second location are different positions of the in-focus range on the laser beam. In these examples, both the first location and the second location may be located with an in-focus range of the laser beam (e.g., the Rayleigh range of the laser beam).

The example scanning mechanism 510 of the measurement system 500 is configured to provide relative movement between the sample holder 503 of the multiwell plate 502 and the set of optics 505. The example scanning mechanism 510 includes a motor 512 and a processor 514 for controlling the motor. The example scanning mechanism 510 allows the relative movement in one or more of a first direction 516 (e.g., along an x-axis), a second direction 518 (e.g., along a y-axis), and a third direction (e.g., along a z-axis). In some examples, the motor 512 moves the sample holder 503 while the set of optics 505 remains static. In other examples, the motor 512 moves the set of optics 505 while the sample holder 503 remains static. In some examples, the motor 512 may move both the sample holder 503 and the set of optics 505. In some examples, a first motor (e.g., the motor 512) may be included to provide movement in the first direction 516 and one or more additional motors may be included to provide movement in the second direction 518 and/or the third direction. Such scanning allows a significant reduction in an amount of time required for the example measurement system 500 to capture measurements of the sample.

A second example measurement system 600 for combining DLS and SLS is shown in FIG. 6. The second example measurement system 600 includes the multiwell plate 502 including the plurality of sample holders including sample holder 503a and sample holder 503b, a set of optics 605, and the scanning mechanism 510. The first example sample holder 503a and the second example sample holder 503b may include portions of a sample (e.g., a pharmaceutical sample) from the same source on which DLS analysis is to be performed.

The example set of optics 605 includes first illumination optics 604 (e.g., a laser source, laser optics, laser launch optics), DLS collection optics 606 (e.g., DLS detector optics), SLS collection optics 608 (e.g., SLS detector optics), and second illumination optics 610. The example first illumination optics 604 are configured to output a first illumination beam (e.g., a laser beam) for the DLS collection optics 606 while the example second illumination optics 610 are configured to output a second illumination beam for the SLS collection optics 608.

A DLS beam output by the DLS collection optics 606 and the first illumination beam output by the first illumination optics 604 intersect at a first location to form a first measurement volume (e.g., a first launch measurement volume, a first collection measurement volume). An SLS beam output by the SLS collection optics 608 and the second illumination beam output by the second illumination optics 610 intersect at a second location to form a second measurement volume (e.g., a second launch measurement volume, a second collection measurement volume). In some examples, the first measurement volume and the second measurement volume are located in the same sample contained in the sample holder (e.g., the sample holder 503a or the sample holder 503b). In other examples, the first measurement volume and the second measurement volume are located in different samples contained in the sample holders (e.g., the first measurement volume is in the sample contained in the sample holder 503a and the second measurement volume is in the sample contained in the sample holder 503b). In this case, the DLS and SLS data for a given sample could be taken sequentially by scanning the optics relative to the sample, or the same sample (e.g., duplicate sample material containing the same pharmaceutical sample) could be placed in two different locations (e.g., the first sample holder 503a and the second sample holder 503b).

### Distribution of Peak Heights Method

Disclosed herein is a method for improving DLS by utilizing a combined DLS/SLS data fitting using distribution of maximum peak heights data generated from SLS-ITT.

### Distribution of Maximum Peak Heights for a Single Species

In general, the light intensity across a laser launch beam (e.g., the illumination beam 202 of FIG. 2) is often not spatially uniform (e.g., often it has a Gaussian intensity profile. The same is often true for the intensity of light gathered by a collector beam (e.g., the collector beam 204 of FIG. 2). With non-spatially uniform laser intensity and collector efficiency, the detection volume d(x, y, z) is given by the multiplication of the light beam intensity profile lₗₐₛₑᵣ(x, y, z) with the collector beam detection efficiency profile L_{det}(x, y, z) as defined in Equation 12 below.

$$d ( x , y , z ) = {I}_{laser} ( x , y , z ) {L}_{det} ( x , y , z ) \qquad ( Equation 12 )$$

The optical power gathered from a scatterer into the detector is maximum in the region where the value of the function d(x, y, z) is largest and decreases with decreasing d. FIG. 2 shows beams (e.g., the illumination beam 202 and the collector beam 204) crossing at an angle θ and the resulting detection volume 206. Below we derive the expected signals for a distribution of particle sizes in a sample with the detection volume moving with respect to the sample for two example cases. The first case includes two Gaussian beams, and the second case includes one Gaussian beam and one “top hat” beam.

### Gaussian Illumination and Collector Beams

In the first case, the illumination beam, typically a laser, and the collector beam both have Gaussian profiles. Gaussian beam profiles are typical for launch from or collection into single mode optical fibers. For mathematical simplicity for illustrative purposes, the special case where the beams cross at 90° is discussed herein. In other examples, the beams may cross at any angle. However, the math has additional complexity not needed for illustrative purposes.

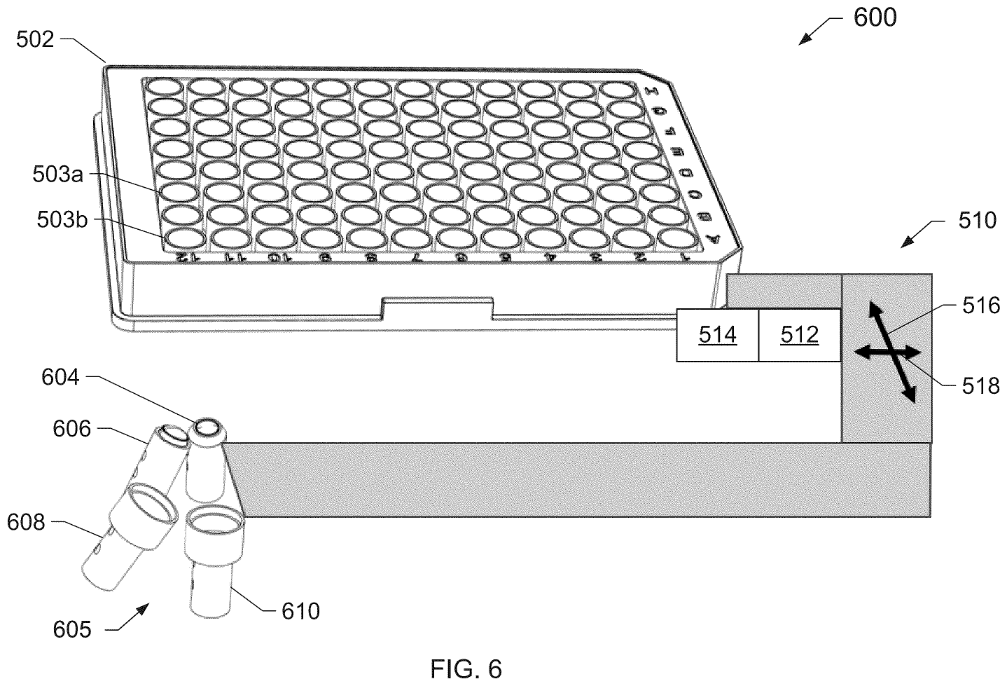

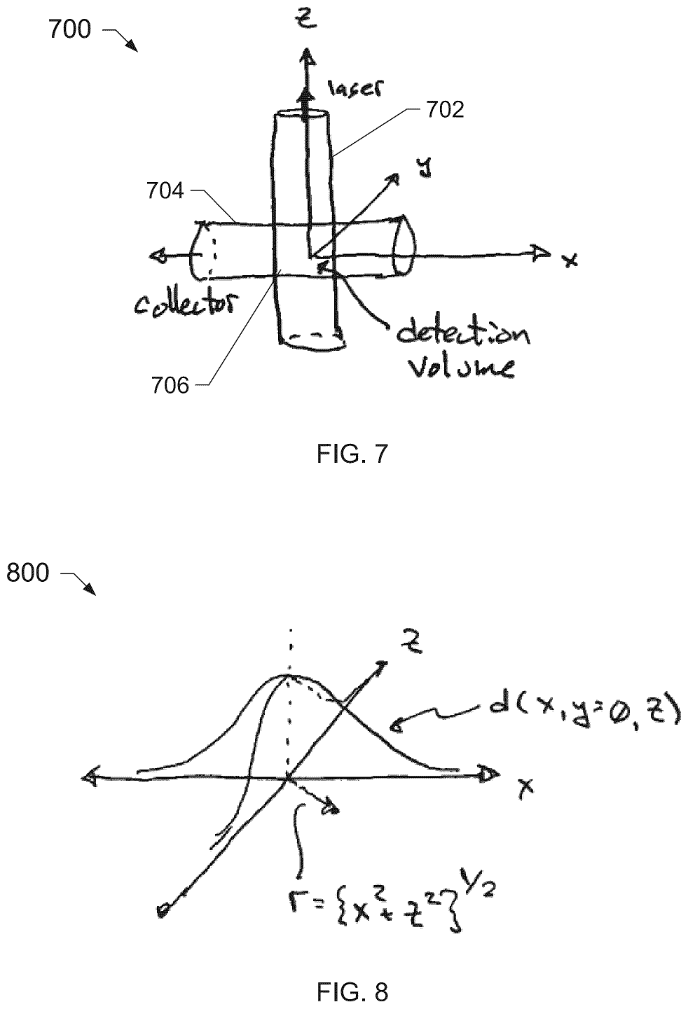

This special case is shown in FIG. 7. FIG. 7 is a schematic diagram 700 of a simplified case of laser beam 702 and a collector beam 704 intersecting at 90 deg. The intersection of the laser beam 702 and the collector beam 704 creates a detection volume 706 (V). With the laser beam 702 propagating in the z direction and the collector beam 704 acquiring light that propagates in the x direction, Gaussian beam intensity profiles are defined by Equation 13 below. In Equation 13, i₀ represents the peak intensity of the laser in the middle of the beam at the minimum beam waist in W/cm², w₀ represents 1/e² minimum beam radius in centimeters, and w(z) represents 1/e² beam radius as a function of position along the beam in centimeters.

$${I}_{laser} ( x , y , z ) = {{i}_{0} ( \frac{{w}_{0}}{w ( z )} )}^{2} exp ( \frac{- 2 ( {x}^{2} + {y}^{2} )}{{w ( z )}^{2}} ) \qquad ( Equation 13 )$$

The functional form for the 1/e² beam radius as a function of position along the beam is given by Equation 14 below. The Rayleigh range ZR of Equation 14 is represented by Equation 15 below where n represents the refractive index of the medium (e.g. water) and λ₀ represents the wavelength of the light in vacuum in centimeters.

$$w ( z ) = {w}_{0} {\{ 1 + {( \frac{z}{{z}_{R}} )}^{2} \}}^{1 / 2} \qquad ( Equation 14 )$$

$${z}_{R} = \frac{π {w}_{0}^{2} n}{{λ}_{0}} \qquad ( Equation 15 )$$

Similarly, the collector beam L_{col}(x, y, z) can be defined as shown in Equation 16 below. In Equation 16, for simplicity, it is assumed that the minimum beam radius w₀ is the same for both beams. Equation 16 may be further simplified by noting that the Rayleigh range z_{R}>>w₀, and so the beam diameter is approximately unchanged across the measurement volume. Equation 16 can then be simplified as given by Equation 17 below with the detection volume d(x, y, z) represented by Equation 18 below.

$${L}_{col} ( x , y , z ) = {{l}_{0} ( \frac{{w}_{0}}{w ( x )} )}^{2} exp ( \frac{- 2 ( {y}^{2} + {z}^{2} )}{{w ( x )}^{2}} ) \qquad ( Equation 16 )$$

$${I}_{laser} ( x , y , z ) ≅ {i}_{0} exp ( \frac{- 2 ( {x}^{2} + {y}^{2} )}{{w}_{0}^{2}} ) , \\ {L}_{col} ( x , y , z ) ≅ {l}_{0} exp ( \frac{- 2 ( {y}^{2} + {z}^{2} )}{{w}_{0}^{2}} ) \qquad ( Equation 17 )$$

$$d ( x , y , z ) = {i}_{0} {l}_{0} exp ( \frac{- 2 ( {x}^{2} + 2 {y}^{2} + {z}^{2} )}{{w}_{0}^{2}} ) = {d}_{0} exp ( \frac{- 2 {r}^{2}}{{w}_{0}^{2}} ) exp ( \frac{- 4 {y}^{2}}{{w}_{0}^{2}} ) \qquad ( Equation 18 )$$

In Equation 18, the detection efficiency d₀=i₀l₀ and r²=x²+z² is the radial distance in the XZ plane from the center of the beam crossing. The detection efficiency d is shown in a diagram 800 of FIG. 8 as a function of (x,z) in the y=0 plane. For illustrative purposes, consider moving this detection volume relative to the sample along the y-axis. For an actual instrument, the beams (e.g., the illumination beam 202 and the collector beam 204) will cross at an angle as shown in FIG. 2 and movement will be along both x and y (e.g. as the detection volume traces a circle or a spiral in solution). Movement along z is also possible.

As an example and using movement along one axis only, for a particle that traverses the detection volume with a velocity ν moving parallel to the y-axis, the intensity of the collected light will increase and then decrease, with the maximum intensity at y=0. The intensity through time is given by Equation 19 below.

$$i ( t ) = {d}_{0} exp ( \frac{- 2 {r}^{2}}{{w}_{0}^{2}} ) exp ( \frac{- 4 {( v ( t - {t}_{0} ) )}^{2}}{{w}_{0}^{2}} ) \qquad ( Equation 19 )$$

The maximum intensity of the peak through time iₚ will be determined by the radial position r of the particle with respect to the center of the detection volume in the XZ plane as shown in Equation 20 below. For species that are large enough to have very little translational diffusion during the time it takes to traverse the detection volume, the intensity through time will have a Gaussian profile with a 1/e² half-width of

$$HW = \frac{{w}_{0}}{v \sqrt{2}} .$$

$${i}_{p} = {d}_{0} exp ( \frac{- 2 {r}^{2}}{{w}_{0}^{2}} ) \qquad ( Equation 20 )$$

In the following example, a single species is present in solution having hydrodynamic radius rₕ [cm] and number density n [#/cm³], and with on average fewer than 1 particle in the detection volume at any one time. As such, nd_{ν}<<1 and as the detection volume moves with respect to the sample and individual particles move one at a time through the detection volume, there will be peaks in the measured intensity through time. The peak heights will have a distribution given by the distribution of the relative cross-sectional areas of detection efficiency in the y=0 plane.

To determine an expected distribution of peak heights for a single species, the detection area in the XZ plane that is within the detection range d and d+δ is calculated. The maximum intensity of the peak through time iₚ as defined in Equation 20 above is inverted to obtain the radius from the beam center as a function of peak intensity as shown in Equation 21 below.

$$r = \frac{{w}_{0}}{\sqrt{2}} {\{ - ln ( \frac{d}{{d}_{0}} ) \}}^{\frac{1}{2}} \qquad ( Equation 21 )$$

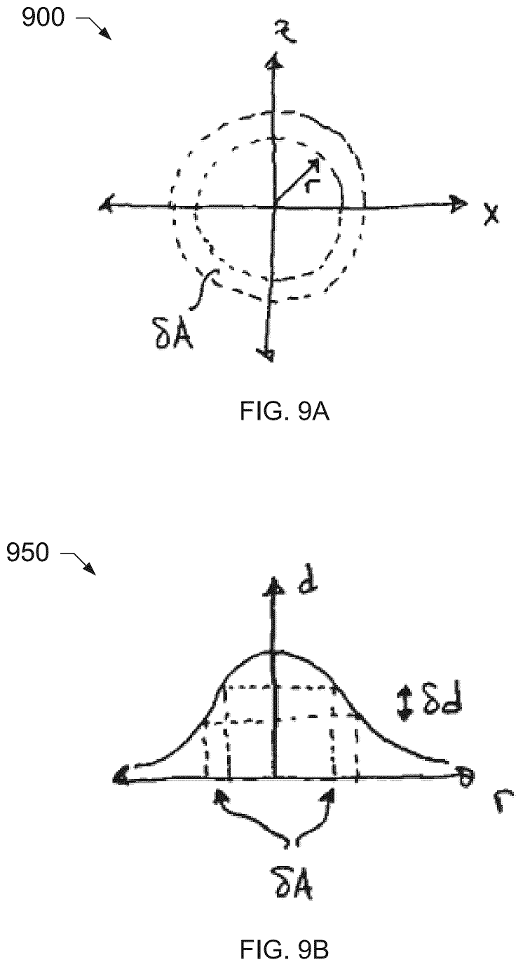

FIG. 9A is a diagram 900 illustrating the distribution of peak heights in the XZ plane while FIG. 9B is a diagram 950 illustrating the distribution of peak heights as a function of radius. The distributions of peak heights shown in diagram 900 and diagram 950 are given by the relative area of a range of detection efficiencies. FIGS. 9A and 9B show that there is very little relative area at the maximum peak intensity and that the majority of the area is near zero intensity. As may be seen in FIG. 6A, the area in the XZ plane for detection efficiencies between d and d+δ is given by Equation 22 below. Using Equation 21 above for r, Equation 22 can be transformed into Equation 23 below.

$$δ A ( d \to d + δ ) = {π [ r ( d ) ]}^{2} - {π [ r ( d + δ ) ]}^{2} \qquad ( Equation 22 )$$

$$δ A ( d \to d + δ ) = \frac{π {w}_{0}^{2}}{2} \{ ln ( \frac{d + δ}{{d}_{0}} ) - ln ( \frac{d}{{d}_{0}} ) \} = \frac{π {w}_{0}^{2}}{2} ln ( \frac{d + δ}{d} ) \qquad ( Equation 23 )$$

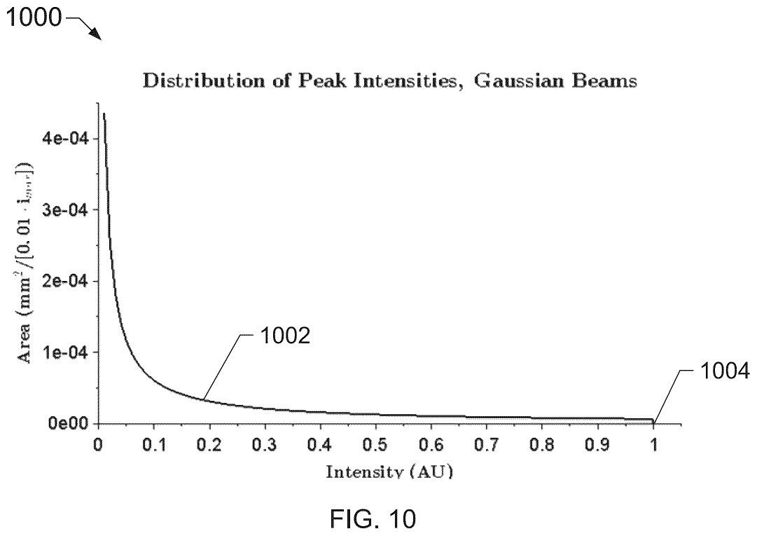

Equation 23 gives the expected detection cross sectional area as a function of detection efficiency, which is equal to the expected distribution of peak heights for two Gaussian beams of equal beam diameters intersecting at 90°. FIG. 10 is a diagram 1000 showing an example curve of expected distribution of peak heights 1002 from a single species with intersecting Gaussian beams. The curve of expected distribution of peak heights 1002 is graphed as the relative area as a function of maximum peak intensity d₀ 1004. The maximum peak intensity d₀ 1004 is exactly the expected relative number of peaks as a function of maximum peak intensity for a single species in solution. The curve of expected distribution of peak heights 1002 may also be referred to as the number of maximum peak intensities N(Γ, I), where Γ is the correlation rate of the species and is proportional to 1/r, and I is maximum intensity of light for a single peak.

As seen in FIG. 10, for this special case of Gaussian illumination and Gaussian collection beams intersecting at 90° for a single species in solution, there is a gradual reduction in the number peaks with increasing maximum peak intensity, with a hard cutoff at the maximum intensity 704. For different species, the intensity value of the hard cutoff will depend on the scattering strength of that species, with larger species generally scattering more strongly.

### Gaussian Illumination and “Top Hat” Collector Beams

In the second case, a Gaussian laser beam and a “top hat” intensity profile collector beam intersect at an angle θ. As used herein, a top hat profile refers to a profile where there is equal collection efficiency everywhere within a tube, with no falloff in efficiency as the edges of the tube are approached, and 0 collection efficiency outside the tube. A top hat profile is approximately the intensity profile expected for light collected into a many-mode fiber with the minimum beam waist at the crossing between the laser and the collector.

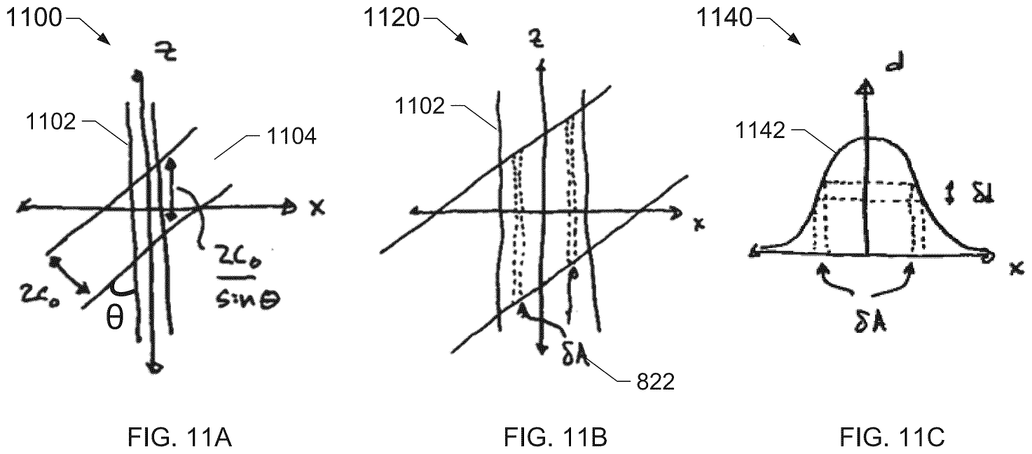

FIG. 11A is a schematic diagram 1100 showing a Gaussian laser beam 1102 intersecting with a “top hat” collector beam 1104. For illustrative purposes, the assumption that the laser and collector have the identical beam radii is relaxed, and the top hat collector is assigned a beam radius of c₀, as shown in FIG. 11A. In other examples, the top hat collector beam radius c₀ may be larger or smaller than a beam radius w₀ of the Gaussian laser beam 1102.

FIG. 11B is diagram 1120 showing peak intensity regions 1122 for the laser configuration of FIG. 11A. In this second case, the areas of equal detection efficiency are strips along the z direction as shown in FIG. 11B. FIG. 11C is a diagram 1140 showing a distribution of peak intensities 842 corresponding to FIGS. 11A and 11B as a function of x.

The relative cross-sectional area as a function of intensity for this case can be determined as in the two Gaussian case described above. Once again, the peak maximum in intensity through time occurs when the particle is at y=0. The width of the peak now varies depending upon where across the top hat profile the particle traverses, and the height of the peak is given by the distance from x-axis as represented in Equation 24 below. To determine the area of equal intensity strips, Equation 24 may be inverted to obtain Equation 25 below. The area of each region of equal intensity is therefore given by Equation 26 below.

$${i}_{p} = {d}_{0} exp ( \frac{- 2 {x}^{2}}{{w}_{0}^{2}} ) \qquad ( Equation 24 )$$

$$x = \frac{{w}_{0}}{\sqrt{2}} {\{ - ln ( \frac{d}{{d}_{0}} ) \}}^{\frac{1}{2}} \qquad ( Equation 25 )$$

$$δ A ( d \to d + δ ) = 2 \frac{2 {c}_{0}}{sin ( θ )} [ x ( d ) - x ( d + δ ) ] \qquad ( Equation 26 )$$

The leading factor of 2 in Equation 26 is present because there are 2 strips with equal intensity, the term

$$\frac{2 {c}_{0}}{sin ( θ )}$$

is the length of the rectangular strip and [x(d)−x(d+δ)] is the width of the strip that spans an intensity range of δ. As a result, Equation 27 as represented below can be found.

$$δ A ( d \to d + δ ) = \frac{4 {c}_{0} {w}_{0}}{\sqrt{2} sin ( θ )} [ {\{ - ln ( \frac{d}{{d}_{0}} ) \}}^{\frac{1}{2}} - {\{ - ln ( \frac{d + δ}{{d}_{0}} ) \}}^{\frac{1}{2}} ] \qquad ( Equation 27 )$$

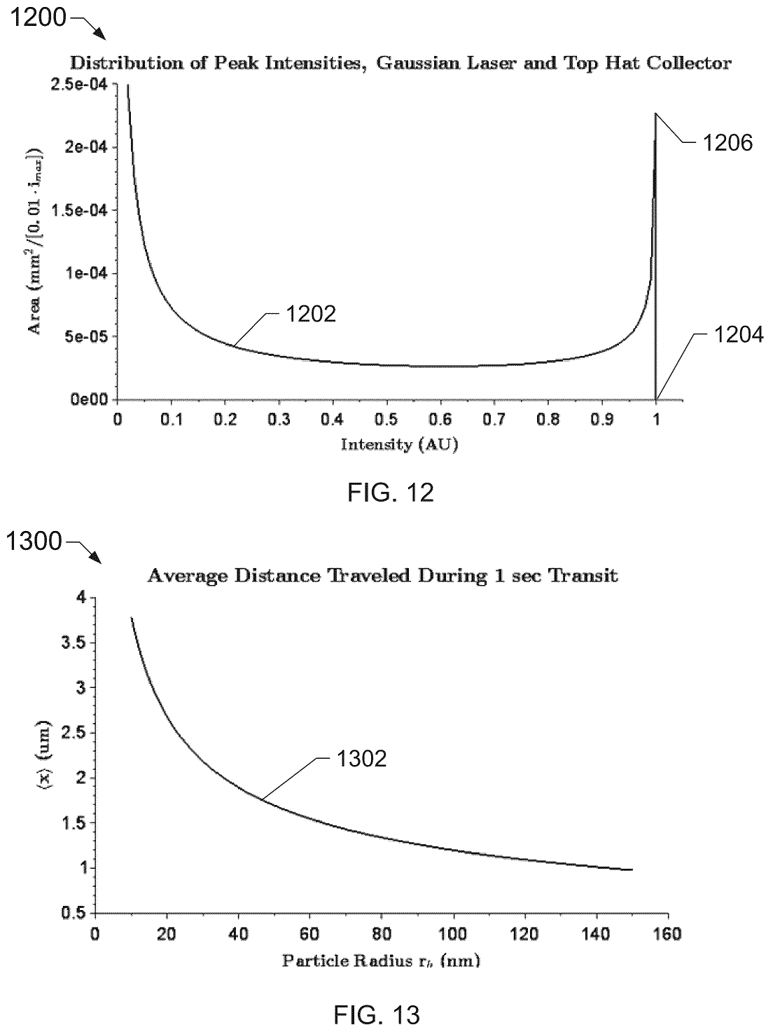

FIG. 12 is diagram 1200 showing an example curve of expected distribution of peak heights 1202 from a single species for a Gaussian laser launch beam and a “top hat” collector profile. The curve of expected distribution of peak heights 1202 is graphed as the relative area as a function of maximum peak intensity d₀ 1204. With regions of equal intensity beings strips rather than annuluses (e.g., washers), there is now a peak 1206 in the area at the region of maximum intensity, as is shown in FIG. 12. The peak 1206 makes the curve of expected distribution of peak heights 1202 associated with a distribution of species more feature-rich than the curve of expected distribution of peak heights 1002 associated with the case of two intersecting Gaussian beams. Thus, the curve of expected distribution of peak heights 1202 is generally preferred over two Gaussian beams.

From the single-species distribution in FIG. 12 it is clear that different distributions of n(r) will have significant differences in the overall distribution of peak heights. As such, the method of a Gaussian laser launch beam and a “top hat” collector profile is likely to provide substantial constraints and hence improvement to regularization fitting.

General Case, Ranging from Gaussian to Top Hat Beams

Above, the distribution for the number of peaks as a function of the maximum peak intensity N(I) was derived for the case of two Gaussian beams intersecting at 90° and for the case of one Gaussian and one top hat beam intersecting at 90°. For two Gaussian beams intersecting at an angle that is not 90°, the expected distribution will lie somewhere between the two-Gaussian case and the Gaussian+top hat case. For two Gaussians where the laser and the collector are co-axial (angle between them of 0°), the expected distribution of peak heights is the same as for the Gaussian+top hat case, although the distribution of peak widths will be different.

### Distribution of Maximum Peak Heights for Multiple Species

Given G(Γ) as the relative scattering intensity into a DLS detector from different species present in solution, with SLS-ITT peak heights measurement the overall distribution of the number of maximum peak intensities as a function of intensity N_{modeled}(I) is given as Equation 28 below. Expressing Equation 28 instead in terms of discreet values of correlation rate Γₚ at discreet values of maximum peak intensity Iₛ (e.g., as would be typical for a numerical analysis) gives Equation 29 below.

$${N}_{modeled} ( I ) = \int G ( Γ ) N ( Γ , I ) d Γ \qquad ( Equation 28 )$$

$${N}_{modeled} ( {I}_{s} ) = {\sum }_{p} G ( {Γ}_{p} ) N ( {Γ}_{p} , {I}_{s} ) \qquad ( Equation 29 )$$

Combining SLS-ITT Peak Height Data with DLS Data

The SLS-ITT peak height data may be combined with DLS data to improve the accuracy and precision of the estimate for G(Γ) by including a chi-squared term associated with SLS-ITT peak height in the overall chi-squared being minimized. This may be given as Equation 30 below where

$${χ}_{DLS}^{2}$$

is defined as in Equation 8 and

$${χ}_{ph}^{2}$$

is defined as in Equation 31 below.

$${χ}^{2} = {χ}_{DLS}^{2} + {γ}_{p h} {χ}_{p h}^{2} \qquad ( Equation 30 )$$

$${χ}_{p h}^{2} = {\sum }_{s} {\{ \frac{{N}_{measured} ( {I}_{s} ) - {N}_{modeled} ( {I}_{s} )}{{σ}_{p h} ( {I}_{s} )} \}}^{2} \qquad ( Equation 31 )$$

In Equation 31, the summation is over the s measured maximum intensity values, σₚₕ(Iₛ) is the estimated noise (typically a standard deviation) in the measured maximum intensity values, and γₚₕ provides a means of weighting the contribution of χₚₕ to the fit relative to χ_{DLS}.

### Distribution of Peak Widths Method

Disclosed herein is a method for improving DLS by utilizing a combined DLS/SLS data fitting using distribution of peak width distributions data generated from SLS-ITT.

During transit of the beam, particles continue to diffuse. If during the transit time, particles move on average a significant distance along the direction of motion as compared to the dimension of the beam waist in the direction of motion, then there will be a broadening of the distribution of peak widths in time. A candidate distribution of particle sizes will have a corresponding distribution of peak widths that may be compared against the data. This corresponding distribution of peak widths may help to constrain a regularization fit. For example, the diffusion coefficient D(r) for a particle of hydrodynamic radius r is given in Equation 32 below. The average distance a particle travels in 3D [symbol] d(r) [symbol] during a time t is given by Equation 33 below. The average distance a particle travels in 3D [symbol] d(r) [symbol] during a time t projected onto one-dimension is represented by Equation 34 below. With a detection volume linear dimension of 40 μm and a speed of movement of ν=40 mm/sec, intensity peaks from particles will have a width in time of approximately 1 second.

$$D ( r ) = \frac{{k}_{B} T}{6 π η r} \qquad ( Equation 32 )$$

$$〈 d ( r ) 〉 = \sqrt{2 D ( r ) t} \qquad ( Equation 33 )$$

$$〈 x ( r ) 〉 = 〈 d ( r ) 〉 / \sqrt{3} \qquad ( Equation 34 )$$

FIG. 13 is a diagram 1300 showing the resulting average movement [symbol] x(r) [symbol] due to diffusion during transit time as a function of particle radius r. FIG. 13 includes a curve of average distance traveled due to diffusion during transit 1302 plotted as a function of radius for a transit time of 1 second. For example, particles that are 20 nm in radius will have approximately a 6% broadening of the distribution of peak widths, and particles that are 100 nm in radius will have approximately a 3% broadening of the distribution of peak widths. With sufficiently controlled conditions and accuracy of measurement, the difference between 3% and 6% broadening would be readily measurable.

Given a particular combination of illumination and collector beam geometries and in the absence of diffusion effects, there will be a characteristic distribution of transit times M_{base}(tₜᵣₐₙₛ). As used herein, transit time tₜᵣₐₙₛ refers to a measure of the peak width in time using a consistent measure such as full width in time at half max of intensity, or full width in time at quarter max of intensity, or full width in time at 1/e² intensity, or some other consistent measure. For each radius particle, the distribution M_{base}(t) will be Gaussian broadened as shown in Equation 35 below, where b(r, t) is provided as defined in Equation 36 below and σ(r) is provided as defined in Equation 37 below. In Equation 37, [symbol] x(r) [symbol] is given by Equation 34 and tₜᵣₐₙₛ for t is given by Equation 33.

$$M ( r , {t}_{trans} ) = \int {M}_{base} ( {t}_{trans} - τ ) b ( r , τ ) d τ \qquad ( Equation 35 )$$

$$b ( r , τ ) = \frac{1}{σ ( r ) \sqrt{2 π}} {e}^{- \frac{1 {τ}^{2}}{2 {σ ( r )}^{2}}} \qquad ( Equation 36 )$$

$$σ ( r ) = \frac{〈 x ( r ) 〉}{v} \qquad ( Equation 37 )$$

Analysis of DLS data is typically performed as a function of correlation rate Γ rather than as a function of radius r, and so it can useful to express functions in terms of Γ. From Equation 2, Equation 3 and Equation 4 we see that r is a simple function of 1/T as can be expressed in Equation 38 below. Thus, any function of r can be expressed as a function of Γ. Similarly, n(r) may be considered equivalent to G(Γ). Using this equivalence, we calculate the expected total distribution of peak widths as shown in Equation 39 below.

$$r = {q}^{2} \frac{{k}_{B} T}{6 π η Γ} \qquad ( Equation 38 )$$

$${M}_{total} ( {t}_{trans} ) = \int G ( Γ ) M ( Γ , {t}_{trans} ) d Γ \qquad ( Equation 39 )$$

Combining SLS-ITT Peak Width Data with DLS Data

The SLS-ITT peak width data may be combined with DLS data to improve the accuracy and precision of the estimate for G(Γ) by including a chi-squared term associated with SLS-ITT peak width in the overall chi-squared being minimized. This may be given as shown in Equation 40 below where

$${χ}_{DLS}^{2}$$

is defined in Equation 7 and

$${χ}_{pw}^{2}$$

is defined in Equation 41 below.

$${χ}^{2} = {χ}_{DLS}^{2} + {γ}_{pw} {χ}_{pw}^{2} \qquad ( Equation 40 )$$

$${χ}_{pw}^{2} = {\sum }_{s} {\{ \frac{{M}_{measured} ( {t}_{trans} ) - {M}_{total} ( {t}_{trans} )}{{σ}_{p w} ( {I}_{s} )} \}}^{2} \qquad ( Equation 41 )$$

In Equation 41, the summation is over the s measured peak width values, σ_{pw}(Iₛ) is the estimated noise (typically a standard deviation) in the measured maximum intensity values, and γ_{pw} provides a means of weighting the contribution of χ_{pw} to the fit relative to χ_{DLS}.

### Moments of the Intensity Distribution Method

Disclosed herein is a method for improving DLS by utilizing a combined DLS/SLS data fitting using moments in the distribution of the SLS intensity through time generated from SLS-ITT.

Relaxing the condition that there are on average fewer than one particle in the measurement volume at a time, FIG. 4A shows an example light intensity through time I(t) and FIG. 4B shows the resulting distribution of intensities P(I) for N>1 particles of one size in the measurement volume, and with a single particle of larger species also transiting the measurement volume creating an observable peak in intensity through time.

Given a single species with on average [symbol] N [symbol] =nV particles in the measurement volume, the time averaged intensity of scattered light (e.g., the first moment of the intensity distribution μ₁) is generally proportional to [symbol] N [symbol] . As the sample is moved relative to the detection volume, the number of particles in the measurement volume will generally fluctuate as \sqrt{N}, resulting in a second moment of the light scattering distribution μ₂ generally proportional to \sqrt{N}. Light scattering signals are generally positive over background, and so there is also generally a non-zero positive skew of the intensity distribution, which is related to the third moment of the intensity distribution μ₃. In general, the relative values of the moments of the light intensity distribution vary as a function of the number of particles in the measurement volume.

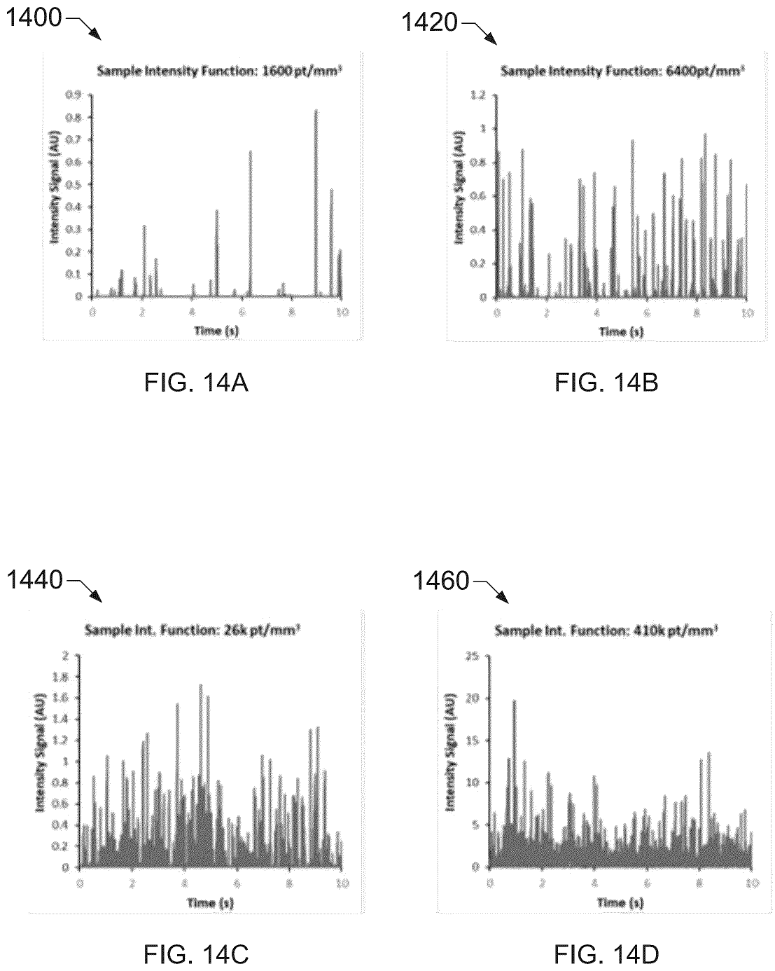

FIGS. 14A-14D are diagrams showing simulated data for intensity through time as the number density of particles increases. For example, diagram 1400 of FIG. 14A shows intensity data for a sample having 1600 particles/mm³, diagram 1420 of FIG. 14B shows intensity data for a sample having 6400 particles/mm³, diagram 1440 of FIG. 14C shows intensity data for a sample having 26,000 particles/mm³, and diagram 1460 of FIG. 14D shows intensity data for a sample having 410,000 particles/mm³.

In the diagram 1400 of FIG. 14A, there are on average fewer than one particle in the measurement volume, and individual intensity spikes are observed. In the diagram 1420 of FIG. 14B and the diagram 1440 of FIG. 14C, the number density of particles is sequentially increased. In the diagram 1460 of FIG. 14D, there are on average a significant number of particles in the measurement volume and so there is almost always some intensity of scattered light, but also with occasional spikes to high intensity.

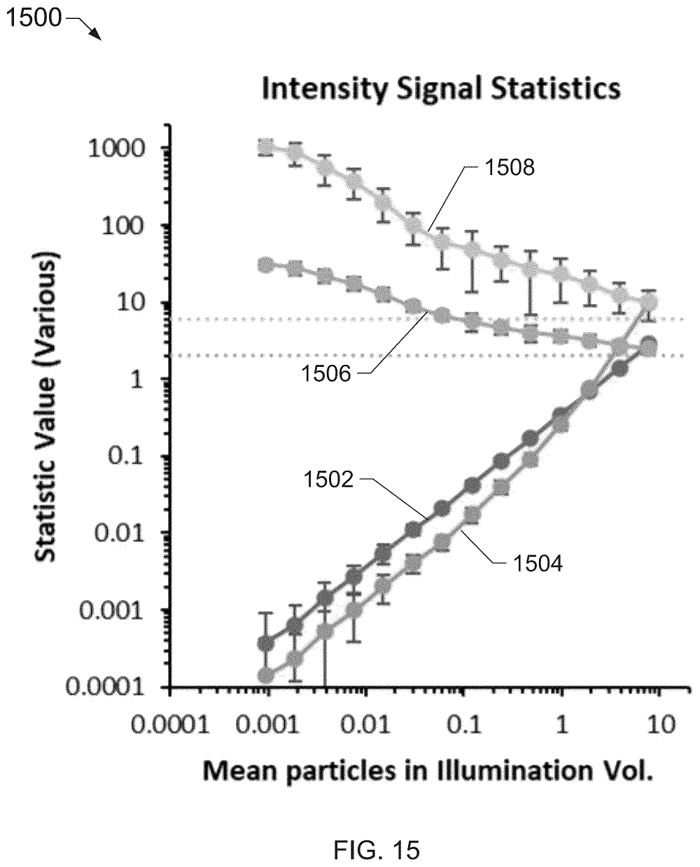

FIG. 15 is a diagram 1500 showing changes in the relative moments of the intensity distribution as a function of number density for a single species in solution. The maximum number density in the diagram 1500 corresponds to 7.7 particles on average in the measurement volume. The diagram 1500 of FIG. 15 shows the 1^{st} moment of the intensity distribution (e.g., mean) 1502, the 2^{nd} moment of the intensity distribution (e.g., variance) 1504, the 3^{rd} moment of the intensity distribution (e.g., skewness) 1506, and the 4^{th} moment of the intensity distribution (e.g., kurtosis) 1508. Each of the moments 1502, 1504, 1506, and 1508 are plotted as a function of the mean number of particles in the measurement volume. The values of the moments change relative to each other as the mean number of particles in the measurement volume increases. Within the regime simulated, it is clear that upon measurement of the intensity through time with a single species in solution, the relative values of these moments alone would allow the mean number of particles in the measurement volume to be accurately estimated.

For the general case of a distribution of species n(r) in the measurement volume, each specific distribution n(r) will result in specific relative values of the moments of the intensity distribution μₙ(n(r)). Determining the general case of μₙ(n(r)) can be achieved with standard mathematical and statistical methods to directly calculate μₙ(n(r)), or by simulating μₙ for various specific n(r) distributions and using interpolation methods to estimate μₙ(n(r)) for distributions which were not directly simulated (e.g. with a lookup table, by measuring un for various specific synthetically created n(r) distributions, using mixtures of known samples, and using interpolation methods to estimate μₙ(n(r)) for distributions which were not directly measured).

If with any of the other methods or similar methods, the moments μₙ(n(r)) are known or reasonably estimated up to some order (e.g. up to the 4th or the 5^{th} moment), then by comparing μ_{n-modeled}(n_{modeled}(r)) against μ_{n-measured} it is possible to eliminate distributions n_{modeled}(r) that are not consistent with Un-measured.

As with the peak heights and the peak widths methods above, it is possible to construct a

$${χ}_{moments}^{2}$$

and to incorporate the total

$${χ}^{2} = {χ}_{DLS}^{2} + {γ}_{moments} {χ}_{moments}^{2} ,$$

with the

$${χ}_{moments}^{2}$$

team weighing the fit away from solutions that are inconsistent with the measured moments of the intensity distribution, thereby improving the accuracy and precision of the estimate of n(r) (equivalent to G(Γ)).

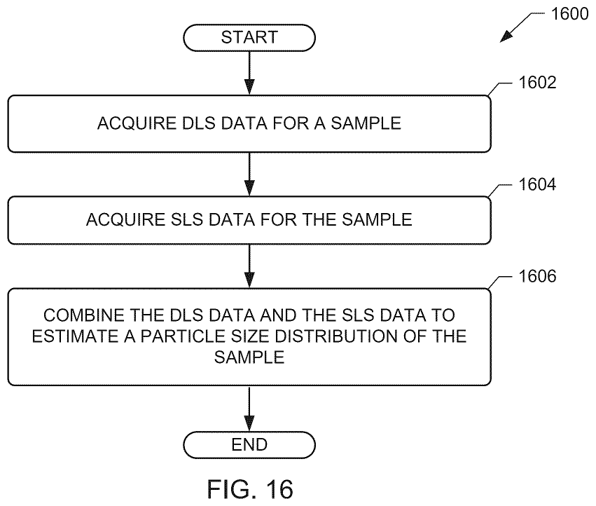

FIG. 16 is a flow diagram illustrating an example procedure 1600 for estimating a particle size distribution, according to an example embodiment of the present disclosure. Although the procedure 1600 is described with reference to the flow diagram illustrated in FIG. 16, it should be appreciated that many other methods of performing the functions associated with the procedure 1600 may be used. For example, the order of the blocks may be changed, certain blocks may be combined with other blocks, and many of the blocks described are optional.

The example procedure 1600 beings at block 1602 when an example measurement system acquires DLS data for a sample. For example, a set of optics of an example measurement system may output a first illumination beam (e.g., a laser beam) and a first detector beam (e.g., a DLS detector beam) and measure DLS data for the sample at a first measurement volume formed by the intersection of the first illumination beam and the DLS detector beam.

At block 1604, the example measurement system acquires SLS data for the sample. For example, the set of optics may output a second illumination beam (e.g., a second laser beam) and a second detector beam (e.g., an SLS detector beam) and measure SLS data for the sample at a second measurement volume formed by the intersection of the second illumination beam and the SLS detector beam. In some examples, the second illumination beam is the same as the first illumination beam. In some examples, a processor (e.g., the processor 514 of FIGS. 5 and 6) may control a motor (e.g., the motor 512 of FIGS. 5 and 6) of the measurement system to scan (e.g., move) the sample relative to the optics while the DLS data is acquired. For example, the sample may be moved while the optics remain fixed or the optics may be moved while the sample remains fixed. The example SLS data acquired may be one or more of a distribution of peak heights, a distribution of peak widths, and/or moments of an intensity distribution. In some examples, acquiring the SLS data includes recording an SLS intensity through time (SLS-ITT) as particles of the sample cross through the measurement volume.

At block 1606, the DLS data and the SLS data are combined to estimate a particle size distribution of the sample. For example, the SLS data may be used to constrain the solutions when solving the DLS data for a particle size distribution of the sample.

### CONCLUSION

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

It should be appreciated that 35 U.S.C. 112 (f) or pre-AIA 35 U.S.C 112, paragraph 6 is not intended to be invoked unless the terms “means” or “step” are explicitly recited in the claims. Accordingly, the claims are not meant to be limited to the corresponding structure, material, or actions described in the specification or equivalents thereof.

The invention is claimed as follows:

1. A measurement device, the measurement device comprising:
a sample holder containing at least a first sample;
a set of optics comprising:
illumination optics;
a first detector beam configured for standard dynamic light scattering (DLS); and
a second detector beam configured for enhancing DLS regularization with static light scattering (SLS) information; and
a scanning mechanism to scan the sample holder relative to the set of optics.

2. The measurement device of claim 1, wherein the illumination optics includes a single laser beam for both the first detector beam and the second detector beam.

3. The measurement device of claim 2, wherein the first detector beam and the second detector beam are directed to approximately the same position on the single laser beam.

4. The measurement device of claim 2, wherein the first detector beam is directed to a first position on the single laser beam and the second detector beam is directed to a second position on the single laser beam and wherein the first position and the second position are both within an in-focus range of the single laser beam.

5. The measurement device of claim 1, wherein the illumination optics include a first laser beam for the first detector beam and a second laser beam for the second detector beam and wherein a first measurement volume is formed by the first laser beam and the first detector beam and a second measurement volume is formed by the second laser beam.

6. The measurement device of claim 5, wherein the first measurement volume and the second measurement volume are in the first sample.

7. The measurement device of claim 6, wherein the scanning mechanism moves the first sample relative to the set of optics for sequential acquisition of SLS and DLS data.

8. The measurement device of claim 5, further comprising a second sample contained in a second sample holder, and wherein the first measurement volume is in the first sample and the second measurement volume is in the second sample.

9. The measurement device of claim 8, wherein the first sample and the second sample include duplicate sample material.

10. The measurement device of claim 1, wherein an intensity profile of the second detector beam is a Gaussian profile.

11. The measurement device of claim 1, wherein an intensity profile of the second detector beam is a top hat profile.

12. The measurement device of claim 1, wherein the SLS information is one or more of a distribution of peak heights, a distribution of peak widths, and moments of an intensity distribution.

13. The measurement device of claim 1, wherein the sample holder is a well of a multiwell plate.

14. The measurement device of claim 1, wherein the sample holder is a cuvette.

15. The measurement device of claim 1, wherein a size of the second detector beam is substantially smaller than a size of the first detector beam.

16. The measurement device of claim 1, wherein a size of the second detector beam is approximately the same as a size of the first detector beam.

17. A method for estimating a particle size distribution of a sample comprising:
acquiring DLS data for a sample;
acquiring SLS data for the sample; and
combining the DLS data and the SLS data to estimate the particle size distribution of the sample.

18. The method of claim 17, wherein the SLS data is one or more of a distribution of peak heights, a distribution of peak widths, and moments of an intensity distribution.

19. The method of claim 17, wherein an illumination beam for acquiring the DLS data is the same beam as an illumination beam for acquiring the SLS data.

20. The method of claim 17, wherein acquiring the SLS data comprises:
one of (i) moving the sample relative to a measurement volume or (ii) moving the measurement volume relative to the sample; and
recording an SLS intensity through time (SLS-ITT) as particles of the sample cross through the measurement volume.
